(19) United States
(12) Patent Application Publication
(10) Pub. No.: US 2007/0284420 A1
(43) Pub. Date: Dec. 13, 2007

(54) INTEGRATED CIRCUIT CHIP FORMED ON SUBSTRATE

(75) Inventors: Teck Tiong Tan, Singapore (SG); Hwee Seng Jimmy Chew, Singapore (SG)

Correspondence Address: CONLEY ROSE, P.C.;David A. Rose, P. O. BOX 3267, HOUSTON, TX, 77253-3267, US

(73) Assignee: ADVANPACK SOLUTIONS PTE LTD, Singapore (SG)

(21) Appl. No.: 11/423,725

(22) Filed: Jun. 13, 2006

(51) Int. Cl. B23K 31/02

(52) U.S. Cl. 228/180.22

(57) ABSTRACT

A method for coupling a semiconductor substrate to a receiving substrate is disclosed. The method comprising the step of providing a receiving substrate having at least one receiving pad formed thereon, the at least one receiving pad having a face and a portion substantially extending from the periphery of the face to the receiving substrate. The method also involves the step of providing a semiconductor substrate having at least one bonding pad formed thereon and at least one pillar extending from the at least one bonding pad towards the at least one receiving pad, the at least one pillar having a reflowable and a non-reflowable portion. The method further involves the step of positioning the semiconductor substrate over the receiving substrate for facing the at least one receiving pad towards the at least one pillar, and reflowing the reflowable portion substantially over the face and substantially onto the portion.

### FIELD OF INVENTION

The invention relates generally to integrated circuits. In particular, the invention relates to a method for forming integrated circuit chips on substrates.

### BACKGROUND

Solder bumps are commonly used in the semiconductor industry for connecting integrated circuit (IC) chips to substrates. With reference to FIG. 1, solder bumps are typically solder balls 10 that are attached to bonding pads 12 of an IC chip 14. The IC chip 14 is subsequently connected to a substrate 18 (see FIG. 2) through a solder bumping process that involves reflowing the solder balls 10.

FIG. 2 shows the IC chip 14 being connected to connecting pads 16 of the substrate 18 after the solder bumping process is completed. The connecting pads 16 are typically formed on the substrate 18 through the use of a layer of solder mask 20.

As IC chips attain higher degrees of functionality and become increasingly complex, the number of bonding pads correspondingly increases. Consequently, the distance or pitch P, as shown in FIG. 1, between adjacent bonding pads 12 decreases. This provides challenges for connecting the IC chip 14 with fine pitch bonding pads to the substrate 18.

The pitch P of bonding pads of IC chips is typically less than 150 micrometers (μm), especially IC chips with fine pitch bonding pads. This means that normal solder balls 10, which usually have diameters of more than 100 μm, are excessively large for attaching to the bonding pads 12 without making electrical or physical contact with other solder balls 10 that are attached to adjacent bonding pads 12.

The solder balls 10 is therefore required to be smaller to be compatible with the reduction in pitch P between adjacent bonding pads 12 and to avoid contacting neighboring solder balls 10. However, this would potentially weaken the connection between the IC chip 14 and the substrate 18. This is because stress is increased at the connection due to a decrease in the space or standoff S between the IC chip 14 and the substrate 18.

Additionally, when smaller solder balls 10 are used, the standoff S between the IC chip 14 and the substrate 18 is not sufficiently large and therefore causes difficulties in filling the space between the IC chip 14 and the substrate 18 with underfilling materials. Examples of underfilling materials are capillary underfill and no-flow underfill (NFU). There is also a higher possibility of excessive solder wicking or spreading of the solder balls 10 when the solder balls 10 are reflowed and connected to the substrate 18, as illustrated in FIG. 2. This would further reduce the standoff S and cause further difficulties in filling the space between the IC chip 14 and the substrate 18 with underfilling materials.

Furthermore, during the solder bumping process, there is a tendency for the solder balls 10 to liquefy and flow to adjacent bonding pads 12 or connecting pads 16. This would undesirably cause bridging between bonding pads 12 or connecting pads 16 and results in electrical shorting.

There is therefore a need for a method for strengthening and improving the reliability of the connection between IC chips with fine pitch bonding pads and substrates, and at the same time providing enough standoff between the IC chips and the substrate for allowing sufficient underfilling capability.

### SUMMARY

Embodiments of the invention disclosed herein strengthens and improves the reliability of the connection between IC chips with fine pitch bonding pads and substrates, and at the same time providing enough standoff between the IC chips and the substrate for allowing sufficient underfilling capability.

In accordance to a first embodiment of the invention, a method for coupling a semiconductor substrate to a receiving substrate is disclosed. The method comprising the step of providing a receiving substrate having at least one receiving pad formed thereon, the at least one receiving pad having a face and a portion substantially extending from the periphery of the face to the receiving substrate. The method also involves the step of providing a semiconductor substrate having at least one bonding pad formed thereon and at least one pillar extending from the at least one bonding pad towards the at least one receiving pad, the at least one pillar having a reflowable and a non-reflowable portion. The method further involves the step of positioning the semiconductor substrate over the receiving substrate for facing the at least one receiving pad towards the at least one pillar, and reflowing the reflowable portion substantially over the face and substantially onto the portion.

In accordance to a second embodiment of the invention, an integrated circuit chip formed on a substrate is disclosed. The integrated circuit chip comprises a receiving substrate having at least one receiving pad formed thereon, the receiving pad having a face and a portion substantially extending from the periphery of the face to the receiving substrate. The integrated circuit chip is formed on a semiconductor substrate having at least one bonding pad formed thereon and at least one pillar extending from the at least one bonding pad towards the at least one receiving pad, the at least one pillar having a reflowable and a non-reflowable portion, wherein the semiconductor substrate is positioned over the receiving substrate for facing the at least one receiving pad towards the at least one pillar, and wherein the reflowable portion is substantially reflowed over the face and substantially onto the portion.

### BRIEF DESCRIPTION OF THE DRAWINGS

Embodiments of the invention are described hereinafter with reference to the drawings, in which:

FIG. 1 is a cross sectional view of a prior art integrated circuit chip having solder balls attached thereto;

FIG. 2 is a cross sectional view of the prior art integrated circuit chip of FIG. 1 connected to a substrate;

FIG. 3 is a flow diagram of a method according to a first embodiment of the invention for coupling a semiconductor substrate to a receiving substrate;

FIG. 4 is a cross sectional view of the semiconductor substrate with pillars extending therefrom;

FIG. 5 is a cross sectional view of the receiving substrate having receiving pads fabricated thereon;

FIG. 6 is a cross sectional view of the semiconductor substrate of FIG. 4 coupled to the receiving substrate of FIG. 5, according to a second embodiment of the invention; and

FIG. 7 is an enlarged cross sectional view of FIG. 6, showing the semiconductor substrate being coupled to the receiving substrate.

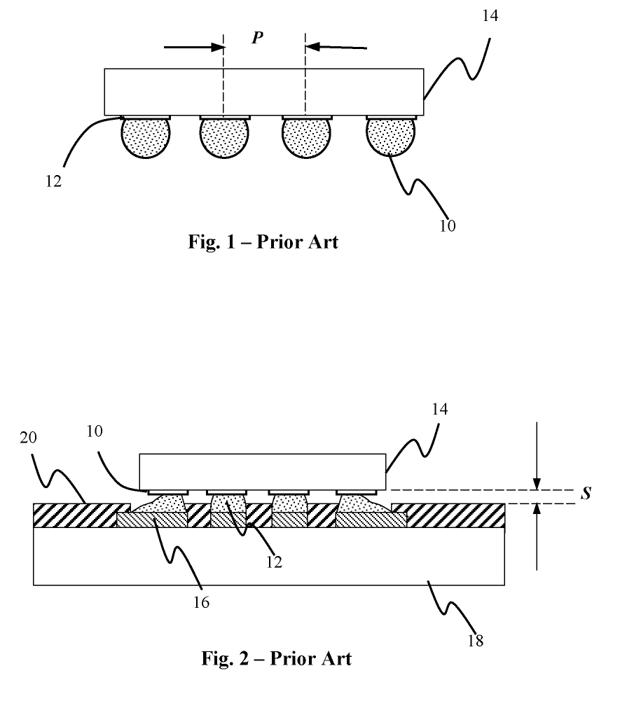

### DETAILED DESCRIPTION

With reference to the drawings, a method for coupling a semiconductor substrate to a receiving substrate according to a first embodiment of the invention is disclosed. Conventional methods make use of solder balls and a solder bumping process for coupling semiconductor substrates to receiving substrates. However, the conventional methods neither provide sufficient strength nor reliability when semiconductor substrates with fine pitch bonding pads are coupled to the receiving substrates. The conventional methods are also unable to provide enough standoff between the semiconductor substrates and the receiving substrates for allowing sufficient underfilling capability.

For purposes of brevity and clarity, the description of the invention is limited hereinafter to a method for strengthening and improving reliability of coupling an integrated circuit chip to a circuit board. This however does not preclude the application of embodiments of the invention to coupling integrated circuit chips to other receiving substrates for achieving similar coupling strength and reliability. The functional principles fundamental to the embodiments of the invention remain the same throughout the variations.

The embodiments of the invention also provide improved underfilling capability between the semiconductor substrates and the receiving substrates. Other advantages of the embodiments of the invention include reducing the risk of solder bridging when the semiconductor substrates are coupled to the receiving substrates and self-alignment of the semiconductor substrates with the receiving substrates.

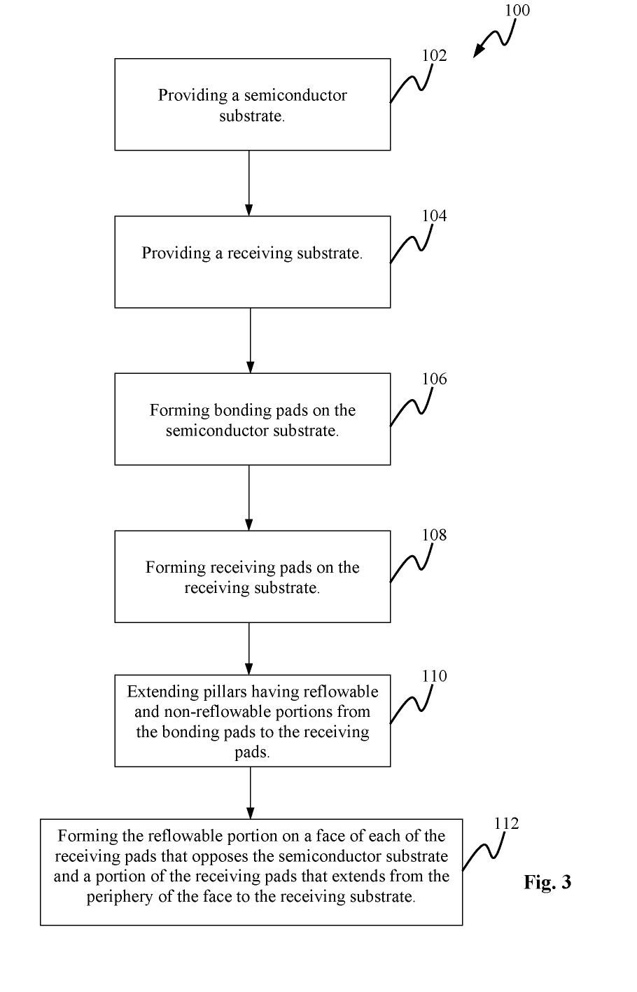

A number of embodiments of the invention are described in greater detail in accordance to FIGS. 3 to 7 of the drawings hereinafter, in which like elements are assigned and labeled with like numerals and described accordingly.

With reference to FIG. 3, a flow diagram of a method comprising steps for coupling a semiconductor substrate to a receiving substrate 100 according to the first embodiment of the invention is shown. The method 100 involves the step of providing a semiconductor substrate 102, such as an integrated circuit chip or a flip chip, and the step of providing a receiving substrate 104, such as a printed circuit board (PCB). The method 100 then involves the step of forming a plurality of bonding pads on one side of the semiconductor substrate 106 for connecting to external circuitries and the step of forming a plurality of receiving pads on the receiving substrate 108 that contains the external circuitries.

The method 100 further involves the step of extending a plurality of pillars from the bonding pads to the receiving pads 110, wherein each of the pillars has a reflowable and a non-reflowable portion. Specifically, the non-reflowable portion is attached to the bonding pads.

The method 100 finally involves the step of reflowing the reflowable portion on a face of each of the receiving pads that opposes the semiconductor substrate 112. The reflowable portion is also substantially formed on a portion of the receiving pads that extends from the periphery of the face to the receiving substrate.

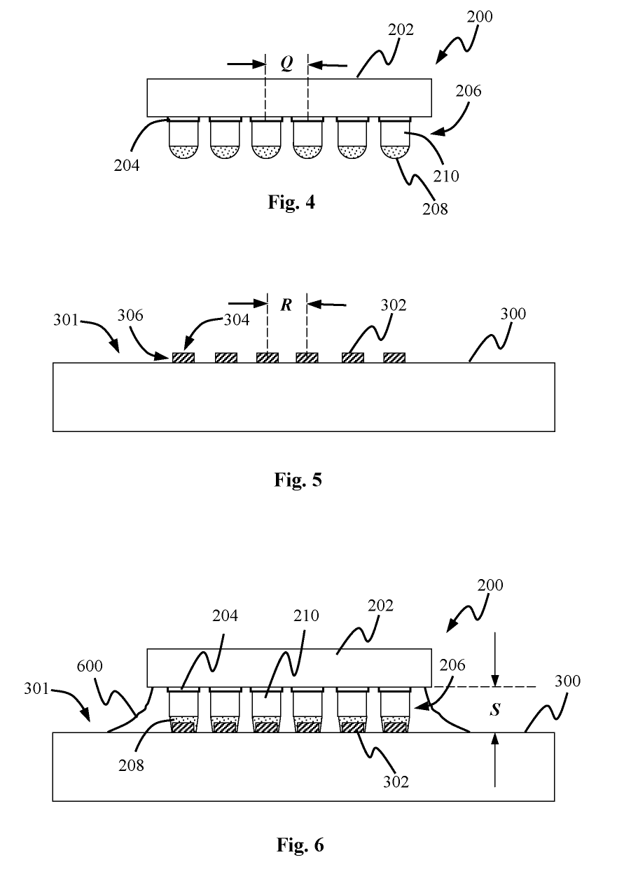

FIGS. 4 to 7 illustrate a second embodiment of the invention in which an integrated circuit chip 200 is formed on a receiving substrate 300 (see FIGS. 5 and 6). As shown in FIG. 4, the integrated circuit chip 200 comprises a semiconductor substrate 202 that has a plurality of bonding pads 204 formed on one side thereof. The distance or pitch Q between adjacent bonding pads 204 is adaptable for fine pitch connections and is preferably equal to or less than 150 micrometers (μm). The bonding pads 204 are preferably made of aluminum (Al).

FIG. 5 shows the receiving substrate 300 that has a planar surface 301 on which the semiconductor substrate 202 is attachable. The receiving substrate 300 has a plurality of receiving pads 302 formed on the planar surface 301. Each of the receiving pads 302 is connectable to a conductive track that extends therefrom and across the planar surface 301 of the receiving substrate 300. The receiving pads 302 are preferably made of copper.

With reference to FIG. 4, a plurality of pillars 206 extends substantially perpendicularly from the semiconductor substrate 202 is shown. The pillars 206 are used for interconnecting the semiconductor substrate 202 to external circuitries formed in the receiving substrate 300. Each of the pillars 206 comprises a reflowable portion 208 and a non-reflowable portion 210. The non-reflowable portion 210 preferably has one end attached to the bonding pads 204 of the semiconductor substrate 202 and the other end coupled with the reflowable portion 208. The pitch between adjacent pillars 206 is substantially equal to the pitch Q of the bonding pads 204 and is preferably equal to or less than 150 μm.

The pitch R between adjacent receiving pads 302 is preferably substantially equal to the pitch Q of the bonding pads 204 and the pillars 206.

The non-reflowable portion 210 preferably has a longitudinal cross sectional area that is substantially similar to that of the bonding pads 204 and extends substantially perpendicularly from the bonding pads 204 towards the receiving pad 302 of the receiving substrate 300 for a predetermined height. The non-reflowable portion is preferably made of copper.

The reflowable portion 208 is preferably made of solder and is attachable to the receiving pads 302 of the receiving substrate 300. The amount of solder used for forming the reflowable portion controls the extent of spreading of the solder when the reflowable portion 208 is reflowed and subsequently attached to the receiving substrate 300.

As illustrated in FIG. 5, each of the receiving pads 302 of the receiving substrate 300 has a predetermined thickness and a face 304 for facing the pillars 206. The face 304 is coatable with a layer of finishing, such as nickel (Ni) or gold (Au). The face 304 is also preferably planar but is not limited to having a geometrical shape that is similar to the longitudinal cross sectional area of the non-reflowable portion 210 of the pillars 206. A portion 306 of the receiving pad 302 that extends from the periphery of the face 304 to the receiving substrate 300 is preferably substantially perpendicular to the face 304.

Additionally, the face 304 preferably has an area that is approximately equal to or smaller than the longitudinal cross sectional area of the non-reflowable portion 210 of the pillars 206. This provides sufficient space between adjacent receiving pads 302 and advantageously prevents solder bridging of adjacent receiving pads 302 during reflowing of the reflowable portion 208 of the pillars 206. Furthermore, there is desirably a larger margin for aligning the pillars 206 with the receiving pads 302.

With reference to FIG. 6, the predetermined height of the non-reflowable portion 210 of the pillars 206 advantageously allowed sufficient space or standoff S between the semiconductor substrate 202 and the receiving substrate 300. This desirably provides enough underfilling capability between the semiconductor substrate 202 and the receiving substrate 300 for filling the space therebetween with underfilling materials. The pillars 206 are preferably formed substantially perpendicular to both the outwardly opposing sides of the semiconductor substrate 202 and the planar surface of the receiving substrate 300.

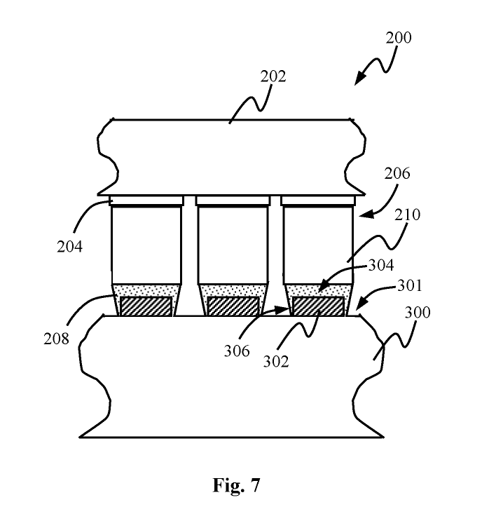

FIG. 7 shows an enlarged cross sectional view of the semiconductor substrate 202 that is positioned over and attached to the receiving substrate 300. The reflowable portions 208 of the semiconductor substrate 202 are reflowed onto the receiving pads 302 using a solder bumping or flip chip bonding process. An underfilling material is introduced by capillary underfill application after the flip chip bonding process is completed for filling the space between the semiconductor substrate 202 and the receiving substrate 300. Alternatively, a dispenser dispenses a predetermined amount of the underfilling material onto the receiving substrate 300 before the flip chip bonding process.

The flip chip bonding process involves heating the reflowable portions 208 in an oven or on a hot plate according to a predetermined temperature profile. The reflowable portions 208 are heated to melting point or beyond, as defined by the predetermined temperature profile, such that each of the reflowable portions 208 becomes softened and consequently began spreading across a corresponding face 304 of the receiving pads 302.

A predetermined amount of solder used for forming each of the reflowable portions 208 is preferably sufficiently adequate for completely covering the corresponding face 304 of the receiving pads 302 and substantially the portion 306 that extends from the periphery of the face 304 to the receiving substrate 300.

During the flip chip bonding process, the plurality of pillars 206 undergoes self-alignment with the receiving pads 302. The non-reflowable portions 210 are self-aligned with the receiving pads 302 when the reflowable portions 208 spread over the faces 304 and onto the portions 306 of the receiving pads 302. The pillars 206 and the semiconductor substrate 202 are consequently aligned with the receiving pads 302 without any additional machinery intervention.

This self-alignment of the pillars 206 with the receiving pads 302 advantageously provides an accurate attachment of the semiconductor substrate 202 to the receiving substrate 300. Accuracy in attaching the semiconductor substrate 202 to the receiving substrate 300 is highly desirable in certain applications, such as those that involve optical sensing chips.

Thereafter, the reflowable portion 208 is cooled down and is subsequently bonded to the receiving pad 302. Because the reflowable portion 208 completely covers and bonds to the face 304 and the portion 306 of the receiving pads 302, strong mechanical locking between the pillars 206 and the receiving pads 302 is achieved. This advantageously increases the strength of the coupling between the semiconductor substrate 202 and the receiving substrate 300.

Integrated circuit chips with fine pitch bonding pads can therefore be formed accurately and reliably on substrates and at the same time having strengthened connection and achieving self-alignment therebetween. Additionally, there is sufficient space between receiving pads formed on the substrates to prevent bridging and also enough standoff between the integrated circuit chips and the substrate to allow sufficient underfilling capability.

Embodiments of the invention are therefore highly desirable for fine pitch applications that require accurate and reliable coupling between the semiconductor substrate 202 and the receiving substrate 300.

Although only a number of embodiments of the invention is disclosed, it becomes apparent to one skilled in the art in view of this disclosure that numerous changes or modification can be made without departing from the scope and spirit of the invention. For example, although the pillars are preferably cylindrical shaped, the pillars may be bonded to the receiving substrate and achieve similar mechanical locking capability between the pillars and the receiving substrate if the pillars are rectangular or polygonal in shape.

1. A method for coupling an integrated circuit chip to a substrate, the method comprising the steps of:
(a) providing a receiving substrate having at least one receiving pad formed thereon, the at least one receiving pad having a face and a portion substantially extending from the periphery of the face to the receiving substrate;
(b) providing a semiconductor substrate having at least one bonding pad formed thereon and at least one pillar extending from the at least one bonding pad towards the at least one receiving pad, the at least one pillar having a reflowable and a non-reflowable portion;
(c) positioning the semiconductor substrate over the receiving substrate for facing the at least one receiving pad towards the at least one pillar; and
(d) reflowing the reflowable portion substantially over the face and substantially onto the portion.

2. The method of claim 1, wherein at least one pillar is self-aligned with the at least one receiving pad for the semiconductor substrate to be self-aligned with the receiving substrate.

3. The method of claim 1, wherein step (a) further comprising the step of coating the least one receiving pad with at least a layer of finishing.

4. The method of claim 1, further comprising the step of filling the space between the semiconductor substrate and the receiving substrate with an underfilling material.

5. The method of claim 1, wherein step (b) further comprising the step of providing a pitch of one of equal to and smaller than 150 micrometers between the at least one bonding pad and an adjacent bonding pad.

6. The method of claim 5, wherein step (a) further comprising the step of providing a pitch between the at least one receiving pad and an adjacent receiving pad that is substantially equal to the pitch between the at least one bonding pad and the adjacent bonding pad.

7. The method of claim 6, wherein step (b) further comprising the step of providing a pitch between the at least one pillar and an adjacent pillar that is substantially equal to the pitch between the at least one bonding pad and the adjacent bonding pad.

8. The method of claim 1, wherein step (b) further comprising the step of extending the at least one pillar substantially perpendicular to the semiconductor substrate and to the receiving substrate.

9. An integrated circuit chip formed on a substrate, comprising:
a receiving substrate having at least one receiving pad formed thereon, the receiving pad having a face and a portion substantially extending from the periphery of the face to the receiving substrate;
a semiconductor substrate having at least one bonding pad formed thereon and at least one pillar extending from the at least one bonding pad towards the at least one receiving pad, the at least one pillar having a reflowable and a non-reflowable portion,
wherein the semiconductor substrate is positioned over the receiving substrate for facing the at least one receiving pad towards the at least one pillar,
wherein the reflowable portion is substantially reflowed over the face and substantially onto the portion.

10. The integrated circuit chip of claim 9, wherein at least one pillar is self-aligned with the at least one receiving pad for the semiconductor substrate to be self-aligned with the receiving substrate.

11. The integrated circuit chip of claim 9, wherein the face provides an area that is substantially equivalent to the longitudinal cross sectional area of the at least one pillar.

12. The integrated circuit chip of claim 9, wherein the face provides an area that is one of smaller and larger than the longitudinal cross sectional area of the at least one pillar.

13. The integrated circuit chip of claim 9, wherein the reflowable portion substantially covers and is bonded to the receiving pad.

14. The integrated circuit chip of claim 9, wherein the amount of spreading of the reflowable portion is determined by the quantity of reflowable portion used.

15. The integrated circuit chip of claim 9, wherein the space between the semiconductor substrate and the receiving substrate is filled with an underfilling material.

16. The integrated circuit chip of claim 9, wherein the pitch between the at least one bonding pad and an adjacent bonding pad is one of equal to and smaller than 150 micrometers.

17. The integrated circuit chip of claim 16, wherein the pitch between the at least one receiving pad and an adjacent receiving pad is substantially equal to the pitch between the at least one bonding pad and the adjacent bonding pad.

18. The integrated circuit chip of claim 16, wherein the pitch between the at least one pillar and an adjacent pillar is substantially equal to the pitch between the at least one bonding pad and the adjacent bonding pad.

19. The integrated circuit chip of claim 9, wherein the face of the at least one receiving pad is substantially planar.

20. The integrated circuit chip of claim 9, wherein the pillar is substantially perpendicular to the semiconductor substrate and to the receiving substrate.

21. The integrated circuit chip of claim 9, wherein the portion of the at least one receiving pad which extends from the periphery of the face to the receiving substrate is substantially perpendicular to the receiving substrate.

22. The integrated circuit chip of claim 9, wherein the reflowable portion is made of solder.
